(19) United States
(12) Patent Application Publication
(10) Pub. No.: US 2024/0064780 A1
(43) Pub. Date: Feb. 22, 2024

(54) Method And Apparatus For Enhancements On Sidelink Over Unlicensed Spectrum Communication

(71) Applicant: MediaTek Singapore Pte. Ltd., Singapore (SG)

(72) Inventors: Jun-Qiang Cheng, Beijing (CN); Tao Chen, Beijing (CN); Jing-Wei Chen, Hsinchu City (TW)

(21) Appl. No.: 18/229,487

(22) Filed: Aug. 2, 2023

(30) Foreign Application Priority Data
Aug. 19, 2022 (WO) PCT/CN2022/113670
Jul. 31, 2023 (CN) 202310947072.6

(51) Int. Cl. H04W 72/40

(52) U.S. Cl. CPC H04W 72/40

(57) ABSTRACT

Various solutions for enhancements on sidelink (SL) over unlicensed spectrum (SL-U) communication are described. An apparatus may operate in a first transmission mode for an SL-U communication with a peer apparatus. The apparatus may determine that a condition associated with the SL-U communication is met. The apparatus may stay in the first transmission mode or switch from the first transmission mode to a second transmission mode for the SL-U communication responsive to the determining.

### CROSS REFERENCE TO RELATED PATENT APPLICATION(S)

The present disclosure is part of a non-provisional application claiming the priority benefit of China Patent Application No. 202310947072.6, filed 31 Jul. 2023 based on PCT Application No. PCT/CN/2022/113670, filed 19 Aug. 2022. The contents of aforementioned applications are herein incorporated by reference in their entirety.

### TECHNICAL FIELD

The present disclosure is generally related to mobile communications and, more particularly, to enhancements on sidelink (SL) over unlicensed spectrum (SL-U) communication.

### BACKGROUND

Unless otherwise indicated herein, approaches described in this section are not prior art to the claims listed below and are not admitted as prior art by inclusion in this section.

Cellular based vehicle-to-everything (V2X) (e.g., long-term evolution (LTE) V2X or new radio (NR) V2X) is a radio access technology developed by the 3 rd generation partnership project (3GPP) to support advanced vehicular applications. In V2X, a direct radio link (also called a sidelink) may be established between two user equipments (UEs) (e.g., mounted on vehicles). The sidelink may operate under the control of a cellular network (e.g., for radio resource allocation) when the UEs are within the coverage of the cellular network. Alternatively, the sidelink may operate independently, e.g., when no cellular network is present or reachable. In particular, sidelink communication is performed via a direct communication interface called PC5 interface.

To meet the increased demands of wireless data traffic, the utilization of unlicensed spectrum has become an option to improve the capacity of future wireless communication systems, including SL communication in 4^{th} generation (4G) LTE or 5^{th} generation (5G) new radio (NR). For fair sharing over unlicensed spectrum, UEs operating on unlicensed spectrum are required to perform a channel access procedure (or called listen-before-talk (LBT)) before any transmission on unlicensed spectrum. However, there is an issue that the uncertain duration of the channel access procedure may cause a long latency before the UEs can transmit on unlicensed spectrum. Another issue with the utilization of unlicensed spectrum is that, after a UE obtains the access to the channel on unlicensed spectrum, the transmission gap(s) may be used by other UEs to occupy the channel and interrupt the transmission. Moreover, for legacy SL, one carrier only has one bandwidth part (BWP), which is supported by all UEs. That is to say, there is only one BWP configuration for all UEs to perform SL communication, which is inefficient in terms of radio resource utilization.

Therefore, there is a need to provide solutions for the aforementioned issues with SL-U communication.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to enhancements on SL-U communication. It is believed that the above-described issue would be avoided or otherwise alleviated by implementing one or more of the proposed schemes described herein.

In one aspect, a method may involve an apparatus operating in a first transmission mode for an SL-U communication with a peer apparatus. The method may also involve the apparatus determining that a condition associated with the SL-U communication is met. The method may further involve the apparatus staying in the first transmission mode or switching from the first transmission mode to a second transmission mode for the SL-U communication responsive to the determining.

In another aspect, a method may involve an apparatus performing a channel access procedure to initiate a channel occupancy time (COT) for SL-U communications with a peer apparatus. The method may also involve the apparatus retaining the COT by filling a gap between two consecutive transmissions.

In yet another aspect, a method may involve an apparatus performing a first SL communication with any one or more of all peer apparatuses according to a first configuration of a common BWP, a common resource pool (RP), or a common resource block (RB) set. The method may also involve the apparatus performing, by the processor, a second SL communication with at least one specific peer apparatus according to a second configuration of a UE-specific BWP, a UE-specific RP, or a UE-specific RB set.

It is noteworthy that, although description provided herein may be in the context of certain radio access technologies, networks and network topologies such as LTE, LTE-Advanced, LTE-Advanced Pro, 5G, NR, Internet-of-Things (IoT) and Narrow Band Internet of Things (NB-IoT), Industrial Internet of Things (IIoT), beyond 5G (B5G), and 6^{th} Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of transmission mode switching under schemes in accordance with implementations of the present disclosure.

FIG. 2 is a diagram depicting an example scenario of access channel retaining under schemes in accordance with implementations of the present disclosure.

FIG. 3 is a block diagram of an example communication system in accordance with an implementation of the present disclosure.

FIG. 4 is a flowchart of an example process under schemes in accordance with an implementation of the present disclosure.

FIG. 5 is a flowchart of an example process under schemes in accordance with an implementation of the present disclosure.

FIG. 6 is a flowchart of an example process under schemes in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhancements on SL-U communication. According to the present disclosure, a number of possible solutions may be implemented separately or jointly. That is, although these possible solutions may be described below separately, two or more of these possible solutions may be implemented in one combination or another.

In the current framework for SL-U communication, devices operating on unlicensed spectrum are required to perform a channel access procedure (or called LBT) before any transmission on unlicensed spectrum, to aid in fair sharing over unlicensed spectrum. However, there are a number of issues with SL-U communication. Firstly, the uncertain duration of the channel access procedure may cause a long latency before a UE can transmit on unlicensed spectrum. Secondly, after a UE obtains the access to the channel on unlicensed spectrum, the transmission gap(s) may be used by other UEs to occupy the channel and interrupt the transmission. Thirdly, the BWP configuration for legacy SL is that one carrier only has one BWP, which is supported by all UEs. That is, there is only one BWP configuration for all UEs to perform SL communication, which is inefficient in terms of radio resource utilization. Therefore, there is a need to provide solutions for the aforementioned issues with SL-U communication.

For the devices operated on unlicensed spectrum, different transmission methods may be required to simplify the channel access procedure. For instance, very-low-power (VLP) operation has been widely used or considered in some regions (e.g., Europe (EU), and China (CN)) for the important 5/6 GHz spectrum. In EU, electric communications Committee (ECC) Decision (20)01 supports Lower Power Indoor (LPI) and VLP devices in 59256425 MHz. VLP is specified for indoor and outdoor use with maximum equivalent isotropically radiated power (EIRP)=14 dBm and maximum EIRP density=−8 dBm/MHz. In CN, VLP operation is supported at 57255850 MHz with maximum EIRP=14 dBm. Similar to short control signaling mechanism and occupied channel bandwidth (OCB) exemption for the simplification of channel access, VLP may be considered as an option to meet regulation requirements.

In view of the above, the present disclosure proposes a number of schemes pertaining to enhancements on SL-U communication. According to some schemes of the present disclosure, a UE is allowed to switch between a first transmission mode (e.g., standard (STD) mode) and a second transmission mode (e.g., VLP mode) for SL-U communication. Specifically, the first transmission mode and the transmission power mode are associated with different thresholds of maximum transmission power (e.g., STD: 23 dBm; VLP: 14 dBm), different channel access settings (e.g., channel access procedures with different sensing durations, or without any channel access procedure), and/or different resource allocation (RA) settings (e.g., different overbooking configurations and/or gap margin configurations with different number of allocated radio resources). Moreover, according to some schemes of the present disclosure, a UE is allowed to retain a channel occupancy time (COT) for SL-U communications by filling a gap between two consecutive transmissions. Additionally, according to some schemes of the present disclosure, multiple BWPs are supported for SL-U or future SL evolution (SL-evo). Specifically, a default or common BWP (or common resource pool (RP) or resource block (RB) set) may be configured for all UEs, while a UE-specific BWP (or UE-specific RP or RB set) may be configured per link (i.e., PC5-radio resource control (RRC) connection). Accordingly, by applying the schemes of the present disclosure, the performance and radio resource utilization of SL-U communication may be improved.

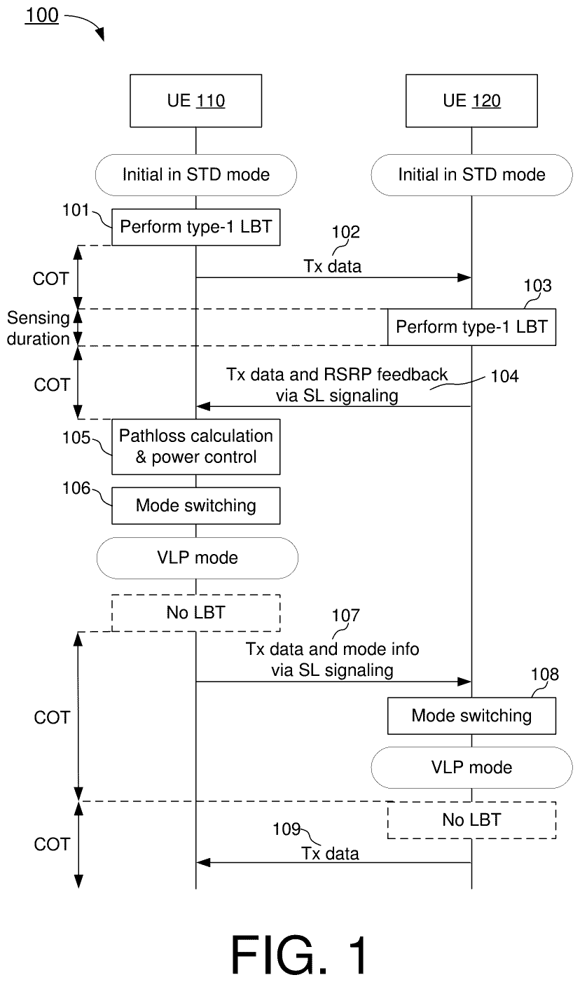

FIG. 1 illustrates an example scenario 100 of transmission mode switching under schemes in accordance with implementations of the present disclosure. Scenario 100 depicts an exemplary message sequence chart of SL-U communication between two UEs 110 and 120. As shown in FIG. 1, both UE 110 and UE 120 initially operate in the STD mode. The initial transmission mode may be determined according to pre-configured maximum EIRP and/or pre-configured maximum EIRP density. For example, the initial transmission mode is the VLP mode if the pre-configured maximum EIRP is less than 14 dBm or the pre-configured maximum EIRP density is less than 1 dBm/MHz; and otherwise, the initial transmission mode is the STD mode.

In step 101, UE 110 performs a type-1 LBT to initiate a COT when operating in the STD mode. In step 102, UE 110 transmits data to UE 120 during the obtained COT. In step 103, UE 120 performs a type-1 LBT to initiate a COT when operating in the STD mode. In some implementations, the type-1 LBT may be performed for a sensing duration, and may be performed with the mechanisms of overbooking and/or gap margin (e.g., with at least one of a overbooking configuration and a gap margin configuration associated with a number of allocated radio resources) to combat the potential channel access failure.

In step 104, UE 120 transmits data and a signal strength feedback (e.g., reference signal received power (RSRP)) to UE 110 during the obtained COT. Specifically, the signal strength feedback may be transmitted via an SL signaling, such as one additional bit in sidelink control information (SCI), a PC5-RRC message, or a PC5-medium access control-control element (MAC-CE). In step 105, UE 110 derives the sidelink pathloss between UE 110 and UE 120, which is further used for power control of UE 110. After the power control, it is assumed that the derived power indicator (e.g., the transmission power and/or the transmission power density) satisfies the requirements of VLP mode as described above. The power control may be performed based on, e.g., the SL pathloss, downlink (DL) pathloss, and/or the (pre-)configured maximum transmission power. For example, UE 110 may determine the transmission power according to the power control (e.g., derived based on the measured SL pathloss and/or (pre-)configured maximum transmission power). If the determined transmission power is smaller than the threshold (e.g., total EIRP power <5 dBm), or the determined transmission power density is smaller than a threshold (e.g., total EIRP density <−8 dBm/MHz), UE 110 may switch to the VLP mode for SL-U communication.

In step 106, UE 110 switches from the STD mode to the VLP mode in response to the condition that at least one derived power indicator is less than at least one threshold (e.g., total EIRP power <5 dBm, and/or total EIRP density <−8 dBm/MHz). It is noteworthy that, when operating in the VLP mode, UE 110 does not need to perform any LBT before starting an SL-U transmission. That is, UE 110 can directly obtain a COT for SL-U communication. Alternatively, when operating in the VLP mode, a UE may need to perform a relaxed LBT (e.g., type-2 LBT) for a smaller sensing duration, and the relaxed LBT may be performed with or without the mechanisms of overbooking and/or gap margin (e.g., with at least one of a overbooking configuration and a gap margin configuration associated with a reduced number of allocated radio resources) before starting an SL-U transmission.

Next, in step 107, UE 110 transmits data and mode information (i.e., information indicating that UE 110 is operating in the VLP mode) to UE 120 during the obtained COT. Specifically, the mode information may be transmitted via an SL signaling, such as one additional bit in SCI, a PC5-RRC message, or a PC5-MAC-CE. In step 108, UE 120 switches from the STD mode to the VLP mode in response to the condition that the mode information of UE 110 is the VLP mode which is different from that of UE 120. Similarly, when operating in the VLP mode, UE 120 does not need to perform any LBT before starting an SL-U transmission, and can directly obtain a COT for SL-U communication. In step 109, UE 120 transmits data to UE 110 during the obtained COT.

In some implementations, each of UE 110 and UE 120 may report its UE capability on whether it supports the VLP mode (e.g., only the VLP mode, both the STD mode and the VLP mode, or only the STD mode). For the case where both the VLP mode and the STD mode are supported by UE 110 or 120, UE 110 or 120 may be further (pre-)configured whether to be allowed operating in the STD mode or the VLP mode.

In some implementations, the determination and/or switching of STD mode and VLP mode may be (pre-)configured and/or indicated by a gNB, and the gNB may share the mode information to eligible UE(s) via RRC and/or MAC-CE and/or one additional bit in physical downlink control channel (PDCCH). Alternatively, the determination and/or switching of STD mode and VLP mode may be (pre-)configured and/or indicated by the cluster header, and the cluster header may share the mode information to eligible UE(s) via PC5-RRC and/or PC5-MAC-CE and/or one additional bit in physical sidelink control channel (PSCCH) or physical sidelink shared channel (PSSCH).

In some implementations, the determination and/or switching of STD mode and VLP mode may be performed according to some other configurations. For example, the mode determination and/or switching may be performed based on the hybrid automatic repeat request (HARQ) feedback (e.g., acknowledgement (ACK) or non-acknowledgement (NACK)), the received signal strength indication (RSSI) or reference signal received power (RSRP) measurement, the traffic loading, and/or the CAPC/priority of the traffic. For example, if a UE operating in the VLP mode receives several NACK feedbacks continuously (e.g., in a (pre-)configured duration), no feedback was received for N (continuous) times, and/or no feedback was received in a (pre-)configured duration, the UE may determine to switch back to the STD mode. If a UE is operating in the STD mode and the measured RSSI is less than a (pre-)configured threshold (e.g., in a specific duration), the UE may determine to switch to the VLP mode.

In some implementations, a UE may be (pre-)configured to report the mode information to a gNB via RRC, MAC-CE (i.e., PUSCH), and/or one additional bit in PUCCH. Additionally, the UE may be (pre-)configured to report the mode information to the cluster header or anchor UE via PC5-RRC, MAC-CE, and/or one additional bit in a first-stage SCI (or called 1st SCI) and/or a second-stage SCI (or called 2 nd SCI). Additionally, the UE may be (pre-)configured to indicate the mode information to the other eligible UE(s) (e.g., the receiver UE(s), COT sharing UE(s), and/or the other UE(s) in the group) via PC5-RRC, MAC-CE, and/or one additional bit in a 1^{st} SCI and/or a 2 nd SCI.

In some implementations, for the case where the SL-U communication includes a transmission in broadcast, if the (pre-)configured maximum EIRP and maximum EIRP density of all UEs can satisfy the requirement of the VLP mode as described above, then the UEs may operate in or switch to the VLP mode. Otherwise, the UEs may operate in the STD mode. For the case where the SL-U communication includes a transmission in groupcast, if the (pre-)configured maximum EIRP and maximum EIRP density of all UEs in the group can satisfy the requirement of the VLP mode, then the UEs in the group may operate in or switch to the VLP mode. Otherwise, the UEs in the group may operate in the STD mode. Additionally, for the case of groupcast, if SL-pathloss-based power control can be used, the UE may operate in or switch to the VLP mode according to whether the highest derived transmission power and/or highest derived transmission power density after the power control of each link satisfies the requirement of the VLP mode. If the SL pathloss based power control cannot be used in the case of groupcast, the UEs in the group may be (pre-)configured to operate in the STD mode.

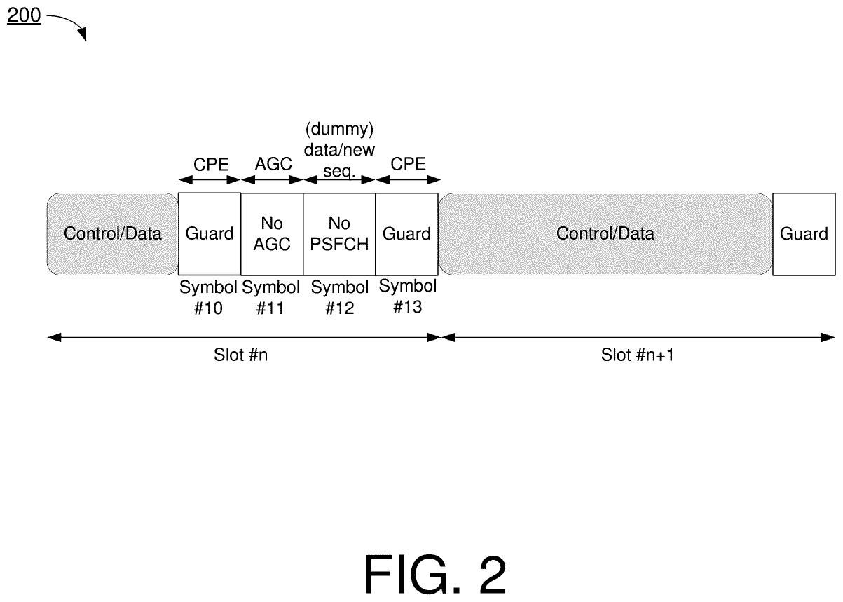

FIG. 2 illustrates an example scenario 200 of access channel retaining under schemes in accordance with implementations of the present disclosure. Scenario 200 depicts an exemplary time sequence of consecutive SL-U transmissions. As shown in FIG. 2, there is no (ACK/NACK) transmission in the symbol of a physical sidelink feedback channel (PSFCH) occasion (denoted as symbol #12), and there is a gap between two consecutive transmissions. Specifically, the gap has a length of 4 symbols, including the guard symbol before the PSFCH occasion (denoted as symbol #10), the automatic gain control (AGC) symbol of the PSFCH occasion (denoted as symbol #11), the symbol of the PSFCH occasion (denoted as symbol #12), and the guard symbol at the end of the slot (denoted as symbol #13). It is noteworthy that, in order to retain the COT, the gap is filled with the operation of cyclic prefix extension (CPE), (dummy) data, and/or a new sequence. For the symbol of the PSFCH occasion (i.e., symbol #12), (dummy) data (e.g., PSSCH data) and/or a new sequence (e.g., a pre-defined sequence such as a PSFCH-like signal) may be transmitted to fill the gap. For the AGC symbol (i.e., symbol #11), the repetition of the PSFCH symbol may be transmitted. For the guard symbol before the PSFCH occasion (i.e., symbol #10), the CPE of the AGC symbol may be transmitted. For the guard symbol at the end of the slot (i.e., symbol #13), the CPE of the transmission of next slot may be transmitted, which may be (pre-)configured or scheduled by the COT initiator.

In some implementations, CPE may be transmitted between any two consecutive SL transmissions by the same or another UE to reduce the gap between the two SL transmissions, such that the gap will not exceed 16 micro-seconds (μs).

In another aspect of the present disclosure, multiple BWPs may be supported for SL communication (e.g., for SL-U or SL-evo). For example, a default BWP (or default RP/RB set) may be (pre-)configured to support unicast, groupcast, and/or broadcast transmission (e.g., for the transmissions without any PC5-RRC connection established in idle/inactive state). To save power of an inactive UE, the inactive UE may only monitor the default BWP (or default RP/RB set) as (pre-)configured. The default BWP may be (pre-)configured with a first number of RBs or RB sets (e.g., only one RB set). The default BWP may be (pre-)configured as a common BWP for all UEs. Additionally, a UE-specific BWP (or UE-specific RP/RB set) may be (pre-)configured to support unicast, groupcast, and/or broadcast transmission (e.g., for the transmissions after a PC5-RRC connection is established in connected state) where the UE capability and preferred BWP size may be negotiated based on the information exchange (e.g., the quality of service (QoS), the channel access priority class (CAPC) of the traffic, the UE capability, or the traffic size). The UE-specific BWP may be (pre-)configured with a second number of RBs or RB sets not smaller than the first number of RBs or RB sets. A UE may switch to the UE-specific BWP (e.g., including the default BWP at least for reception/monitoring) for SL communication. That is, the SL transmission from Tx UE may be performed using any resources within the UE-specific BWP, and the Rx UE may receive such SL transmission, as well as the SL transmissions (unicast/broadcast) from other UEs in the resources within the default BWP. Accordingly, the UE does not need to monitor all RBs or RB sets all the time, and only needs to monitor the RB(s) or RB set(s) of the default BWP.

### Illustrative Implementations

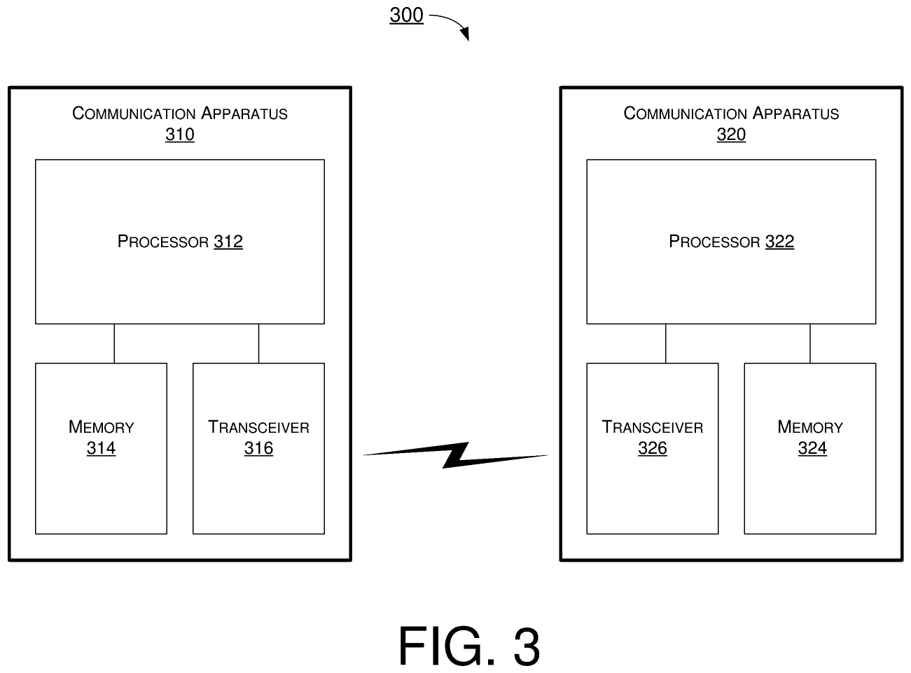

FIG. 3 illustrates an example communication system 300 having at least two communication apparatuses 310 and 320 in accordance with an implementation of the present disclosure. Each of communication apparatus 310 and communication apparatus 320 may perform various functions to implement schemes, techniques, processes and methods described herein pertaining to enhancements on SL-U communication, including scenarios/schemes described above as well as processes 400, 500, and 600 described below.

Each of communication apparatus 310 and communication apparatus 320 may be a part of an electronic apparatus, which may be a UE, such as a portable or mobile apparatus, a wearable apparatus, a vehicular device or a vehicle, a wireless communication apparatus or a computing apparatus. For instance, each of communication apparatus 310 and communication apparatus 320 may be implemented in a smartphone, a smart watch, a personal digital assistant, an electronic control unit (ECU) in a vehicle, a digital camera, or a computing equipment such as a tablet computer, a laptop computer or a notebook computer. Each of communication apparatus 310 and communication apparatus 320 may also be a part of a machine type apparatus, which may be an IoT apparatus such as an immobile or a stationary apparatus, a home apparatus, a roadside unit (RSU), a wire communication apparatus or a computing apparatus. For instance, each of communication apparatus 310 and communication apparatus 320 may be implemented in a smart thermostat, a smart fridge, a smart door lock, a wireless speaker or a home control center.

In some implementations, each of communication apparatus 310 and communication apparatus 320 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of communication apparatus 310 and communication apparatus 320 may be implemented in or as a UE. Each of communication apparatus 310 and communication apparatus 320 may include at least some of those components shown in FIG. 3 such as a processor 312 and a processor 322, respectively, for example. Each of communication apparatus 310 and communication apparatus 320 may further include one or more other components not pertinent to the proposed scheme of the present disclosure (e.g., internal power supply, display device and/or user interface device), and, thus, such component(s) of communication apparatus 310 and communication apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC or RISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including those pertaining to enhancements on SL-U communication in accordance with various implementations of the present disclosure.

In some implementations, communication apparatus 310 may also include a transceiver 316 coupled to processor 312. Transceiver 316 may be capable of wirelessly transmitting and receiving data. In some implementations, transceiver 316 may be capable of wirelessly communicating with different types of UEs/wireless networks of different radio access technologies (RATs). In some implementations, transceiver 316 may be equipped with a plurality of antenna ports (not shown) such as, for example, four antenna ports. That is, transceiver 316 may be equipped with multiple transmit antennas and multiple receive antennas for multiple-input multiple-output (MIMO) wireless communications. In some implementations, communication apparatus 320 may also include a transceiver 326 coupled to processor 322. Transceiver 326 may include a transceiver capable of wirelessly transmitting and receiving data. In some implementations, transceiver 326 may be capable of wirelessly communicating with different types of UEs/wireless networks of different RATs. In some implementations, transceiver 326 may be equipped with a plurality of antenna ports (not shown) such as, for example, four antenna ports. That is, transceiver 326 may be equipped with multiple transmit antennas and multiple receive antennas for MIMO wireless communications.

In some implementations, communication apparatus 310 may further include a memory 314 coupled to processor 312 and capable of being accessed by processor 312 and storing data therein. In some implementations, communication apparatus 320 may further include a memory 324 coupled to processor 322 and capable of being accessed by processor 322 and storing data therein. Each of memory 314 and memory 324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314 and memory 324 may include a type of read-only memory (ROM) such as mask ROM, programmable ROM (PROM), erasable programmable ROM (EPROM) and/or electrically erasable programmable ROM (EEPROM). Alternatively, or additionally, each of memory 314 and memory 324 may include a type of non-volatile random-access memory (NVRAM) such as flash memory, solid-state memory, ferroelectric RAM (FeRAM), magnetoresistive RAM (MRAM) and/or phase-change memory. Alternatively, or additionally, each of memory 314 and memory 324 may include a universal integrated circuit card (U ICC).

Each of communication apparatus 310 and communication apparatus 320 may be a communication entity capable of communicating with each other using various proposed schemes in accordance with the present disclosure. For illustrative purposes and without limitation, a description of capabilities of communication apparatus 310, as a UE (e.g., UE 110/120), and communication apparatus 320, as a peer UE (e.g., UE 110/120), is provided below.

Under certain proposed schemes in accordance with the present disclosure, processor 312 of communication apparatus 310, implemented in or as a UE, may operate in a first transmission mode for an SL-U communication with a peer UE. Additionally, processor 312 may determine that a condition associated with the SL-U communication is met. Furthermore, processor 312 may stay in the first transmission mode or switch from the first transmission mode to a second transmission mode for the SL-U communication responsive to the determining.

In some implementations, processor 312 may also receive, via transceiver 316, a signal strength feedback from the peer apparatus, and perform a power control for the SL-U communication according to the signal strength feedback. The condition may specify whether at least one power indicator derived from the power control is less than at least one threshold associated with the second transmission mode or not.

In some implementations, the signal strength feedback may include an RSRP measured by the peer apparatus during the SL-U communication when the peer apparatus is operating in the first transmission mode, and the at least one power indicator may include at least one of a transmission power and a transmission power density.

In some implementations, processor 312 may also receive, via transceiver 316, mode information indicating whether the peer apparatus is operating in the first transmission mode or the second transmission mode from the peer apparatus via an SL signaling. The condition may specify that the mode information indicates the peer apparatus is operating in the second transmission mode.

In some implementations, the SL signaling may include a SCI, a PC5-RRC message, or a PC5-MAC-CE.

In some implementations, processor 312 may also perform, via transceiver 316, a first channel access procedure for a first sensing duration before starting a transmission to the peer apparatus when the apparatus is operating in the first transmission mode. Additionally, processor 312 may perform, via transceiver 316, a second channel access procedure for a second sensing duration less than the first sensing duration, or refrain from performing any channel access procedure, before starting a transmission to the peer apparatus when the apparatus is operating in the second transmission mode.

In some implementations, processor 312 may also perform, via transceiver 316, a first channel access procedure before starting a transmission to the peer apparatus when the apparatus is operating in the first transmission mode. Specifically, the first channel access procedure may be performed with at least one of a first overbooking configuration and a first gap margin configuration associated with a first number of allocated radio resources. Additionally, processor 312 may perform, via transceiver 316, a second channel access procedure or refrain from performing any channel access procedure before starting a transmission to the peer apparatus when the apparatus is operating in the second transmission mode. Specifically, the second channel access procedure may be performed with at least one of or without any of a second overbooking configuration and a second gap margin configuration associated with a second number of allocated radio resources less than the first number of allocated radio resources.

In some implementations, the first transmission mode may be an STD mode, and the second transmission mode may be a VLP mode.

In some implementations, the STD mode may be associated with at least one first threshold of a maximum transmission power or a maximum transmission power density, while the VLP mode may be associated with at least one second threshold of a derived transmission power or a derived transmission power density, and the at least one second threshold may be less than the at least one first threshold.

In some implementations, the operating in the first transmission mode for the SL-U communication may be determined according to at least one of a pre-configured maximum transmission power and a pre-configured maximum transmission power density.

Under certain proposed schemes in accordance with the present disclosure, processor 312 of communication apparatus 310, implemented in or as a UE, may perform, via transceiver 316, a channel access procedure to initiate a COT for SL-U communications with a peer apparatus. Additionally, processor 312 may retain the COT by filling a gap between two consecutive transmissions.

In some implementations, the filling of the gap between two consecutive transmissions may include: processor 312 transmitting, via transceiver 316, a CPE in one or more guard symbols.

In some implementations, the one or more guard symbols may include at least one of a first guard symbol before an AGC symbol of a PSFCH and a second guard symbol at the end of an SL slot.

In some implementations, the filling of the gap between two consecutive transmissions may include: processor 312 transmitting, via transceiver 316, data or a pre-defined sequence in a symbol corresponding to a PSFCH occasion where no ACK and NACK is to be transmitted.

In some implementations, the data may include PSSCH data, and the pre-defined sequence may include a PSFCH-like signal.

Under certain proposed schemes in accordance with the present disclosure, processor 312 of communication apparatus 310, implemented in or as a UE, may perform, via transceiver 316, a first SL communication with any one or more of all peer apparatuses according to a first configuration of a common BWP, a common RP, or a common RB set. Additionally, processor 312 may perform, via transceiver 316, a second SL communication with at least one specific peer apparatus according to a second configuration of a UE-specific BWP, a UE-specific RP, or a UE-specific RB set.

In some implementations, the first SL communication may include a unicast, groupcast, or broadcast transmission or reception without a PC5-RRC connection established with the one of all peer apparatuses.

In some implementations, the second SL communication may include a unicast, groupcast, or broadcast transmission or reception after a PC5-RRC connection is established with the at least one specific peer apparatus.

In some implementations, the UE-specific BWP may not be smaller than the common BWP.

In some implementations, the common BWP may include a first number of RB sets, and the UE-specific BWP may include a second number of RB sets not smaller than the first number of RB sets.

In some implementations, processor 312 may also monitor, via transceiver 316, only the first number of RB sets for the first SL communication.

In some implementations, each of the first SL communication and the second SL communication may include an SL-U communication.

### Illustrative Processes

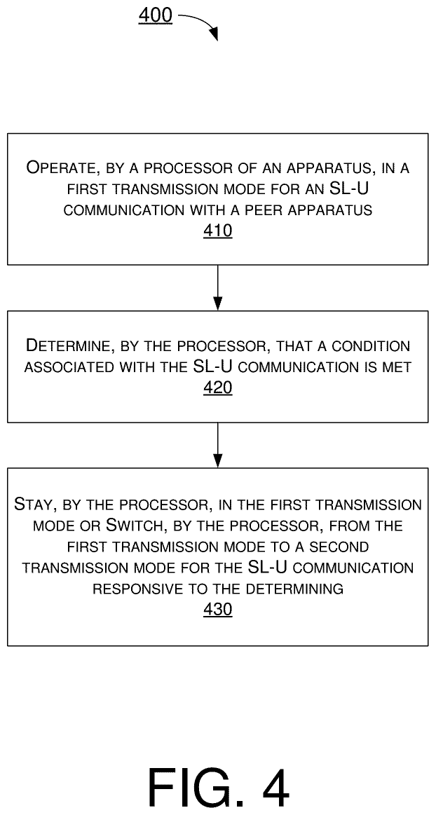

FIG. 4 illustrates an example process 400 under schemes in accordance with an implementation of the present disclosure. Process 400 may represent an aspect of implementing various proposed designs, concepts, schemes, systems and methods described above, whether partially or entirely, including those described above. More specifically, process 400 may represent an aspect of the proposed concepts and schemes pertaining to enhancements on SL-U communication, and, more particularly, to transmission mode switching in SL-U communication. Process 400 may include one or more operations, actions, or functions as illustrated by one or more of blocks 410, 420, and 430. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. Furthermore, one or more of the blocks/sub-blocks of process 400 may be executed iteratively. Process 400 may be implemented by or in communication apparatus 310 and communication apparatus 320 as well as any variations thereof. Solely for illustrative purposes and without limiting the scope, process 400 is described below in the context of communication apparatus 310 as a UE (e.g., UE 110/120) and communication apparatus 320 as a peer UE (e.g., UE 110/120). Process 400 may begin at block 410.

At block 410, process 400 may involve processor 312 of communication apparatus 310, implemented in or as a UE, operating in a first transmission mode for an SL-U communication with a peer apparatus. Process 400 may proceed from block 410 to block 420.

At block 420, process 400 may involve processor 312 determining that a condition associated with the SL-U communication is met. Process 400 may proceed from block 420 to block 430.

At block 430, process 400 may involve processor 312 staying in the first transmission mode or switching from the first transmission mode to a second transmission mode for the SL-U communication responsive to the determining.

In some implementations, process 400 may further involve processor 312 receiving, via transceiver 316, a signal strength feedback from the peer apparatus, and performing a power control for the SL-U communication according to the signal strength feedback. The condition may specify whether at least one power indicator derived from the power control is less than at least one threshold associated with the second transmission mode or not. For instance, the condition may specify that the at least one power indicator derived from the power control is less than the at least one threshold associated with the second transmission mode (e.g., transmission power after power control <14 dBm), such that processor 312 determines to stay in the first transmission mode (e.g., VLP mode) or to switch from the first transmission mode to the second transmission mode (e.g., from STD mode to VLP mode). Alternatively, the condition may specify that the at least one power indicator derived from the power control is greater than or equal to the at least one threshold associated with the second transmission mode (e.g., transmission power after power control ≥14 dBm), such that processor 312 determines to stay in the first transmission mode (e.g., STD mode) or to switch from the first transmission mode to the second transmission mode (e.g., from VLP mode to STD mode).

In some implementations, the signal strength feedback may include an RSRP measured by the peer apparatus during the SL-U communication when the peer apparatus is operating in the first transmission mode, and the at least one power indicator may include at least one of a transmission power and a transmission power density.

In some implementations, process 400 may further involve processor 312 receiving, via transceiver 316, mode information indicating that the peer apparatus is operating in the first transmission mode or the second transmission mode from the peer apparatus via an SL signaling. The condition may specify whether the information indicates the peer apparatus is operating in the first transmission mode or the second transmission mode. For instance, the condition may specify that the information indicates the peer apparatus is operating in the first transmission mode, such that processor 312 determines to stay in the first transmission mode (e.g., STD mode or VLP mode). Alternatively, the condition may specify that the information indicates the peer apparatus is operating in the second transmission mode, such that processor 312 determines to switch from the first transmission mode to the second transmission mode (e.g., from STD mode to VLP mode, or from VLP mode to STD mode).

In some implementations, the SL signaling may include a SCI, a PC5-RRC message, or a PC5-MAC-CE.

In some implementations, process 400 may further involve processor 312 performing, via transceiver 316, a first channel access procedure for a first sensing duration before starting a transmission to the peer apparatus when the apparatus is operating in the first transmission mode. Additionally, process 400 may involve processor 312 performing, via transceiver 316, a second channel access procedure for a second sensing duration less than the first sensing duration, or refraining from performing any channel access procedure, before starting a transmission to the peer apparatus when the apparatus is operating in the second transmission mode.

In some implementations, process 400 may further involve processor 312 performing, via transceiver 316, a first channel access procedure before starting a transmission to the peer apparatus when the apparatus is operating in the first transmission mode. Specifically, the first channel access procedure may be performed with at least one of a first overbooking configuration and a first gap margin configuration associated with a first number of allocated radio resources. Additionally, process 400 may involve processor 312 performing, via transceiver 316, a second channel access procedure or refraining from performing any channel access procedure before starting a transmission to the peer apparatus when the apparatus is operating in the second transmission mode. Specifically, the second channel access procedure may be performed with at least one of or without any of a second overbooking mechanism and a second gap margin mechanism associated with a second number of allocated radio resources less than the first number of allocated radio resources.

In some implementations, the first transmission mode may be one of an STD mode and a VLP mode, and the second transmission mode may be the other of the STD mode and the VLP mode.

In some implementations, the STD mode may be associated with at least one first threshold of a maximum transmission power or a maximum transmission power density, while the VLP mode may be associated with at least one second threshold of a derived transmission power or a derived transmission power density, and the at least one second threshold may be less than the at least one first threshold.

In some implementations, the operating in the first transmission mode for the SL-U communication may be determined according to at least one of a pre-configured maximum transmission power and a pre-configured maximum transmission power density.

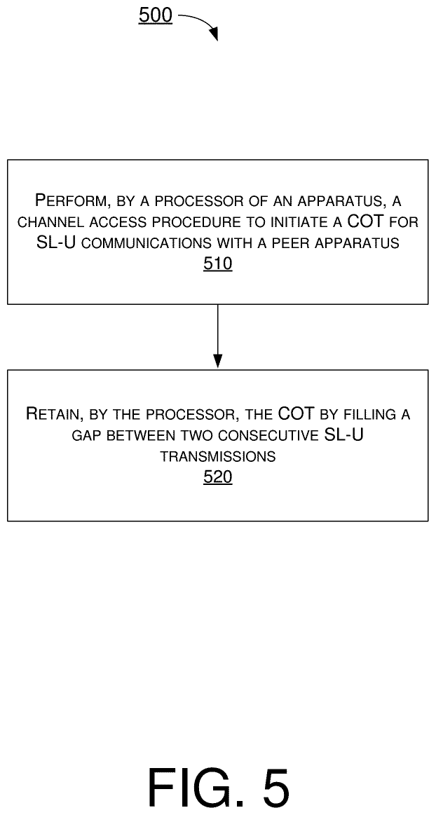

FIG. 5 illustrates an example process 500 under schemes in accordance with an implementation of the present disclosure. Process 500 may represent an aspect of implementing various proposed designs, concepts, schemes, systems and methods described above, whether partially or entirely, including those described above. More specifically, process 500 may represent an aspect of the proposed concepts and schemes pertaining to enhancements on SL-U communication, and, more particularly, to access channel retaining in SL-U communication. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks/sub-blocks of process 500 may be executed in the order shown in FIG. 5 or, alternatively in a different order. Furthermore, one or more of the blocks/sub-blocks of process 500 may be executed iteratively. Process 500 may be implemented by or in communication apparatus 310 and communication apparatus 320 as well as any variations thereof. Solely for illustrative purposes and without limiting the scope, process 500 is described below in the context of communication apparatus 310 as a UE (e.g., UE 110/120) and communication apparatus 320 as a peer UE (e.g., UE 110/120). Process 500 may begin at block 510.

At block 510, process 500 may involve processor 312 of communication apparatus 310, implemented in or as a UE, performing, via transceiver 316, a channel access procedure to initiate a COT for SL-U communications with a peer apparatus. Process 500 may proceed from block 510 to block 520.

At block 520, process 500 may involve processor 312 retaining the COT by filling a gap between two consecutive transmissions.

In some implementations, the filling of the gap between two consecutive transmissions may include: processor 312 transmitting, via transceiver 316, a CPE in one or more guard symbols.

In some implementations, the one or more guard symbols may include at least one of a first guard symbol before an AGC symbol of a PSFCH and a second guard symbol at the end of an SL slot.

In some implementations, the filling of the gap between two consecutive transmissions may include: processor 312 transmitting, via transceiver 316, data or a pre-defined sequence in symbols corresponding to a PSFCH occasion where no ACK and NACK is to be transmitted.

In some implementations, the data may include PSSCH data, and the pre-defined sequence may include a PSFCH-like signal.

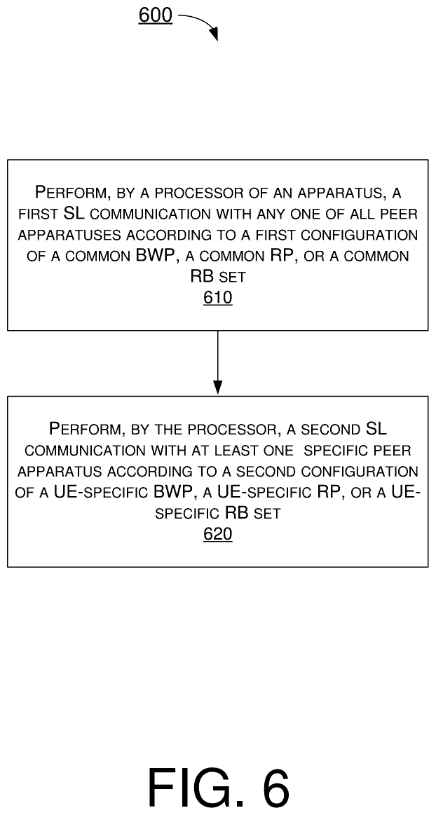

FIG. 6 illustrates an example process 600 under schemes in accordance with an implementation of the present disclosure. Process 600 may represent an aspect of implementing various proposed designs, concepts, schemes, systems and methods described above, whether partially or entirely, including those described above. More specifically, process 600 may represent an aspect of the proposed concepts and schemes pertaining to enhancements on SL-U communication, and, more particularly, to supporting multiple BWPs for SL-U or SL-evo communication. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively in a different order. Furthermore, one or more of the blocks/sub-blocks of process 600 may be executed iteratively. Process 600 may be implemented by or in communication apparatus 310 and communication apparatus 320 as well as any variations thereof. Solely for illustrative purposes and without limiting the scope, process 600 is described below in the context of communication apparatus 310 as a UE (e.g., UE 110/120) and communication apparatus 320 as a peer UE (e.g., UE 110/120). Process 600 may begin at block 610.

At block 610, process 600 may involve processor 312 of communication apparatus 310, implemented in or as a UE, performing, via transceiver 316, a first SL communication with any one or more of all peer apparatuses according to a first configuration of a common BWP, a common RP, or a common RB set. Process 600 may proceed from block 610 to block 620.

At block 620, process 600 may involve processor 312 performing, via transceiver 316, a second SL communication with at least one specific peer apparatus according to a second configuration of a UE-specific BWP, a UE-specific RP, or a UE-specific RB set.

In some implementations, the first SL communication may include a unicast, groupcast, or broadcast transmission or reception without a PC5-RRC connection established with the one of all peer apparatuses.

In some implementations, the second SL communication may include a unicast, groupcast, or broadcast transmission or reception after a PC5-RRC connection is established with the at least one specific peer apparatus.

In some implementations, the UE-specific BWP may not be smaller than the common BWP with or without overlapping between the UE-specific BWP and the common BWP.

In some implementations, the common BWP may include a first number of RBs or RB sets, and the UE-specific BWP may include a second number of RBs or RB sets not smaller than the first number of RBs or RB sets.

In some implementations, process 600 may further involve processor 312 monitoring, via transceiver 316, only the first number of RBs or RB sets for the first SL communication.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
operating, by a processor of an apparatus, in a first transmission mode for a sidelink (SL) over unlicensed spectrum (SL-U) communication with a peer apparatus;
determining, by the processor, that a condition associated with the SL-U communication is met; and
staying, by the processor, in the first transmission mode or switching, by the processor, from the first transmission mode to a second transmission mode for the SL-U communication responsive to the determining.

2. The method of claim 1, further comprising:
receiving, by the processor, a signal strength feedback from the peer apparatus; and
performing, by the processor, a power control for the SL-U communication according to the signal strength feedback;
wherein the condition specifies whether at least one power indicator derived from the power control is less than at least one threshold associated with the second transmission mode or not.

3. The method of claim 2, wherein the signal strength feedback comprises a reference signal received power (RSRP) measured by the peer apparatus during the SL-U communication, and wherein the at least one power indicator comprises at least one of a transmission power and a transmission power density.

4. The method of claim 1, further comprising:
receiving, by the apparatus, mode information indicating that the peer apparatus is operating in the first transmission mode or the second transmission mode from the peer apparatus via an SL signaling,
wherein the condition specifies whether the mode information indicates the peer apparatus is operating in the first transmission mode or the second transmission mode.

5. The method of claim 4, wherein the SL signaling comprises a sidelink control information (SCI), a PC5-radio resource control (RRC) message, or a PC5-medium access control-control element (MAC-CE).

6. The method of claim 1, further comprising:
performing, by the processor, a first channel access procedure for a first sensing duration before starting a transmission to the peer apparatus when the apparatus is operating in the first transmission mode; and
performing, by the processor, a second channel access procedure for a second sensing duration less than the first sensing duration, or refraining from performing any channel access procedure, before starting a transmission to the peer apparatus when the apparatus is operating in the second transmission mode.

7. The method of claim 1, further comprising:
performing, by the processor, a first channel access procedure before starting a transmission to the peer apparatus when the apparatus is operating in the first transmission mode, wherein the first channel access procedure is performed with at least one of a first overbooking configuration and a first gap margin configuration associated with a first number of allocated radio resources; and
performing, by the processor, a second channel access procedure or refraining from performing any channel access procedure before starting a transmission to the peer apparatus when the apparatus is operating in the second transmission mode, wherein the second channel access procedure is performed with at least one of or without any of a second overbooking mechanism and a second gap margin mechanism associated with a second number of allocated radio resources less than the first number of allocated radio resources.

8. The method of claim 1, wherein the first transmission mode is one of a standard (STD) mode and a very-low-power (VLP) mode, and the second transmission mode is the other of the STD mode and the VLP mode.

9. The method of claim 8, wherein the STD mode is associated with at least one first threshold of a maximum transmission power or a maximum transmission power density, while the VLP mode is associated with at least one second threshold of a derived transmission power or a derived transmission power density, and wherein the at least one second threshold is less than the at least one first threshold.

10. A method, comprising:
performing, by a processor of an apparatus, a channel access procedure to initiate a channel occupancy time (COT) for sidelink (SL) over unlicensed spectrum (SL-U) communications with a peer apparatus; and
retaining, by the processor, the COT by filling a gap between two consecutive transmissions.

11. The method of claim 10, wherein the filling of the gap between two consecutive transmissions comprises:
transmitting, by the processor, a cyclic prefix extension (CPE) in one or more guard symbols.

12. The method of claim 11, wherein the one or more guard symbols comprise at least one of a first guard symbol before an automatic gain control (AGC) symbol of a physical sidelink feedback channel (PSFCH) and a second guard symbol at the end of an SL slot.

13. The method of claim 10, wherein the filling of the gap between two consecutive transmissions comprises:
transmitting, by the processor, data or a pre-defined sequence in symbols corresponding to a physical sidelink feedback channel (PSFCH) occasion where no acknowledgement (ACK) and non-acknowledgement (NACK) is to be transmitted.

14. The method of claim 13, wherein the data comprises physical sidelink shared channel (PSSCH) data, and wherein the pre-defined sequence comprises a PSFCH-like signal.

15. A method, comprising:
performing, by a processor of an apparatus, a first sidelink (SL) communication with any one or more of all peer apparatuses according to a first configuration of a common bandwidth part (BWP), a common resource pool (RP), or a common resource block (RB) set; and
performing, by the processor, a second SL communication with at least one specific peer apparatus according to a second configuration of a UE-specific BWP, a UE-specific RP, or a UE-specific RB set.

16. The method of claim 15, wherein the first SL communication comprises a unicast, groupcast, or broadcast transmission or reception without a PC5-radio resource control (RRC) connection established with the one of all peer apparatuses.

17. The method of claim 15, wherein the second SL communication comprises a unicast, groupcast, or broadcast transmission or reception after a PC5-radio resource control (RRC) connection is established with the at least one specific peer apparatus.

18. The method of claim 15, wherein the UE-specific BWP is not smaller than the common BWP with or without overlapping between the UE-specific BWP and the common BWP.

19. The method of claim 15, wherein the common BWP comprises a first number of RBs or RB sets, and wherein the UE-specific BWP comprises a second number of RBs or RB sets not smaller than the first number of RBs or RB sets.

20. The method of claim 19, further comprising:
monitoring, by the processor, only the first number of RBs or RB sets for the first SL communication.
